(19) United States
(12) Patent Application Publication
(10) Pub. No.: US 2025/0304188 A1
(43) Pub. Date: Oct. 2, 2025

(54) VEHICLE STRUCTURE

(71) Applicants: Hyundai Motor Company, Seoul (KR); Kia Corporation, Seoul (KR)

(72) Inventor: Seung Min Jeong, Hwaseong-si (KR)

(21) Appl. No.: 18/798,013

(22) Filed: Aug. 8, 2024

(30) Foreign Application Priority Data
Apr. 2, 2024 (KR) 10-2024-0044750

(51) Int. Cl. B62D 25/20; B60K 1/04; B62D 21/02

(52) U.S. Cl. CPC B62D 25/2027; B60K 1/04; B62D 21/02; B60K 2001/0438

(57) ABSTRACT

A vehicle structure can include a rear side member coupled to a rear side of a center side member, a mounting hole formed in a kick-up portion of the rear side member so as to be open backward and downward, and a mounting bracket inserted into and coupled to the mounting hole and configured to rotatably support a front end portion of a trailing arm.

### CROSS-REFERENCE TO RELATED APPLICATIONS

This application claims priority from Korean Patent Application No. 10-2024-0044750, filed on Apr. 2, 2024, in the Korean Intellectual Property Office, the disclosure of which is incorporated herein by reference in its entirety.

### TECHNICAL FIELD

The present disclosure is related to a structure of a vehicle.

### BACKGROUND

As customer demands for vehicles have been diversified, there have been developed vehicle structures such as purpose built vehicles (PBVs) that include a drive module, in which parts related to driving of a vehicle are modularized, and a life module, in which a vehicle body that is actually used by an occupant is modularized.

PBVs commonly use a drive module responsible for driving the vehicle, and allow various life modules to be selected and mounted therein according to customer demands, thereby satisfying various customer demands at a relatively low cost.

It is desirable for the aforementioned life module to secure as large a passenger compartment or a cargo carrying space as possible. It is also desirable for the floor of the passenger compartment or the cargo carrying space to form as flat a surface as possible.

The information disclosed in this Background section is only for enhancement of understanding of the general background of the disclosure, and should not be taken as an acknowledgement or any form of suggestion that this information forms the related art already publicly known, available, or in use.

### SUMMARY

The present disclosure is related to a structure of a vehicle.

In view of the above problems, an embodiment of the present disclosure can provide a vehicle structure, in which the floor of a passenger compartment or a cargo carrying space forms as flat a surface as possible and which is capable of securing a sufficient space for mounting of a rear suspension and securing sufficient rigidity of a part for mounting of the rear suspension, thereby effectively preparing for a rear collision of a vehicle and, especially, effectively protecting a battery of an electric vehicle in the event of a rear collision of the electric vehicle.

In accordance with an embodiment of the present disclosure, the above and other advantages can be accomplished by the provision of a vehicle structure including a rear side member coupled to a rear side of a center side member, a mounting hole formed in a kick-up portion of the rear side member so as to be open backward and downward, and a mounting bracket inserted into and coupled to the mounting hole and configured to rotatably support a front end portion of a trailing arm.

The rear side member may be formed to have a U-shaped section and to be elongated in the forward-backward direction of a vehicle, and the mounting bracket may be formed to have an inverted U-shaped section so as to overlap and to be inserted into the U-shaped section of the rear side member, and may be coupled to the rear side member so as to surround the entire periphery of the mounting hole to block communication between an upper side of the rear side member and a lower side of the rear side member.

The front end portion of the trailing arm may be inserted into and mounted in the mounting bracket so that a rotary shaft of the trailing arm is located inside the U-shaped section of the rear side member and the inverted U-shaped section of the mounting bracket.

The portion of the rear side member in which the mounting hole is open may be formed to have a relatively large width in the lateral direction of the vehicle.

The vehicle structure may further include a rear cross member mounted farther inward than the mounting hole and extending in the lateral direction of the vehicle and a rear cross extension mounted between the rear cross member and the rear side member and expanding in a direction from the rear cross member toward the rear side member so as to surround the portion of the rear side member in which the mounting hole is formed.

The vehicle structure may further include an outer reinforcing member mounted farther outward than the rear side member to surround and reinforce the portion of the rear side member in which the mounting hole is formed.

The vehicle structure may further include a side sill mounted farther outward than the center side member and extending in the forward-backward direction of the vehicle, and a rear end portion of the side sill and the outer reinforcing member may be connected to each other via a side sill connection reinforcing member and may be supported by the side sill connection reinforcing member.

The side sill connection reinforcing member may include a surface perpendicular to the rotary shaft of the trailing arm and a surface parallel to the rotary shaft of the trailing arm and connected to the surface perpendicular to the rotary shaft of the trailing arm. The surface perpendicular to the rotary shaft of the trailing arm may be configured so as to support the rotary shaft of the trailing arm together with the outer reinforcing member, and the surface parallel to the rotary shaft of the trailing arm may be in surface contact with and coupled to a rear surface of the side sill.

The vehicle structure may further include a front reinforcing bracket mounted inside the rear side member at a position in front of the mounting bracket to enhance coupling rigidity between the mounting bracket and the rear side member.

The front reinforcing bracket may be mounted so as to overlapping a portion of the rear side member, as well as overlapping and coupled to the center side member.

The vehicle structure may further include an inner reinforcing bracket mounted inside the rear side member and interposed between the rear side member and a portion of the mounting bracket oriented in the inward direction of the vehicle to enhance coupling rigidity between the mounting bracket and the rear side member, and to connect the mounting bracket to the rear cross member via the rear side member and the rear cross extension.

The vehicle structure may further include a weld nut coupled to the inner reinforcing bracket, and a mounting bolt coupled to the rotary shaft of the trailing arm during a process of forming the rotary shaft. The rotary shaft may be fastened to the weld nut.

The mounting bracket may include an inner mounting bracket surrounding portions of the rear side member located farther inward, forward, and backward than the mounting hole and an outer mounting bracket coupled to the inner mounting bracket and surrounding a portion of the rear side member located farther outward than the mounting hole.

The portion of the rear side member in which the mounting hole is formed may be a portion from which the rear side member coupled to the center side member extends backward and upward.

The vehicle structure may further include a rear wheel house panel coupled to an upper side of the rear side member. The rear wheel house panel may include a front end portion coupled to the side sill.

The vehicle structure may further include a suspension support bracket coupled to the rear side member at a position behind the mounting hole to mount a rear suspension.

The center side member may be provided in a pair, and the pair of center side members may be symmetrically positioned on both sides of the vehicle. A battery may be mounted between the pair of center side members and may be fixed to the pair of center side members and the rear cross member.

### BRIEF DESCRIPTION OF THE DRAWINGS

The above and other features and advantages of the present disclosure can be more clearly understood from the following detailed description taken in conjunction with the accompanying drawings, in which:

FIG. 1 is a rear perspective view (viewed from below) of a vehicle structure according to an embodiment of the present disclosure;

FIG. 2 is an exploded view of main parts shown in FIG. 1;

FIG. 3 is a detailed view of the main parts shown in FIG. 2;

FIG. 4 is a detailed view (viewed from above) of the parts shown in FIG. 3;

FIG. 5 is an exploded view (viewed from above) of some of the parts shown in FIG. 4;

FIG. 6 is a top perspective view showing a state in which a mounting bracket, a front reinforcing bracket, and an inner reinforcing bracket are coupled inside a rear side member;

FIG. 7 is a perspective view (viewed from above) of main parts shown in FIG. 1;

FIG. 8 is a rear perspective view showing an example in which a side sill connection reinforcing member is further provided;

FIG. 9 is a cross-sectional view taken along line F9-F9 in FIG. 7;

FIG. 10 is a cross-sectional view taken along line F10-F10 in FIG. 7;

FIG. 11 is a cross-sectional view taken along line F11-F11 in FIG. 9;

FIG. 12 is a bottom view of an electric vehicle equipped with a battery, to which an embodiment of the present disclosure is applied; and

FIG. 13 is a cross-sectional view taken along line F13-F13 in FIG. 7.

### DETAILED DESCRIPTION OF ILLUSTRATIVE EMBODIMENTS

Hereinafter, example embodiments disclosed in the present specification will be described in detail with reference to the accompanying drawings, and same or similar elements are denoted by the same reference numerals even though they are depicted in different drawings, and redundant descriptions thereof can be omitted.

In the following description, with respect to constituent elements used in the following description, the suffixes “module” and “unit” may be used only in consideration of facilitation of description, and do not have mutually distinguished meanings or functions.

In the following description of example embodiments disclosed in the present specification, a detailed description of known functions and configurations incorporated herein can be omitted when the same may make the subject matter of the embodiments disclosed in the present specification rather unclear. In addition, the accompanying drawings are provided only for a better understanding of the example embodiments disclosed in the present specification and are not intended to limit the technical ideas disclosed in the present specification. Therefore, it can be understood that the accompanying drawings include all modifications, equivalents, and substitutions within scopes and sprit of the present disclosure.

It can be understood that although the terms “first”, “second”, etc., may be used herein to describe various components, these components are not necessarily limited by these terms. These terms can be used merely to distinguish one component from another component.

It can be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form can be intended to include the plural forms as well, unless the context clearly indicates otherwise.

It can be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

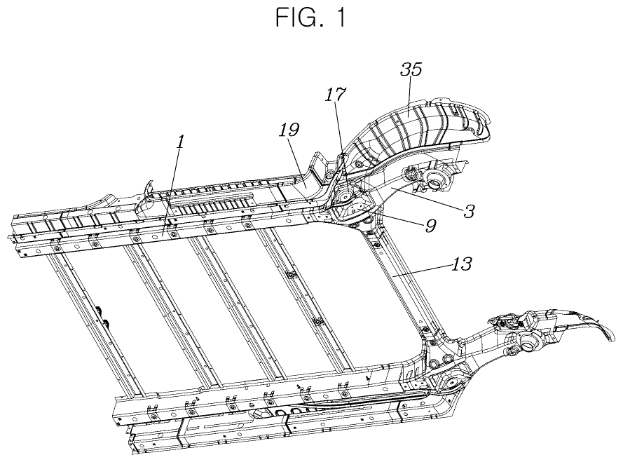

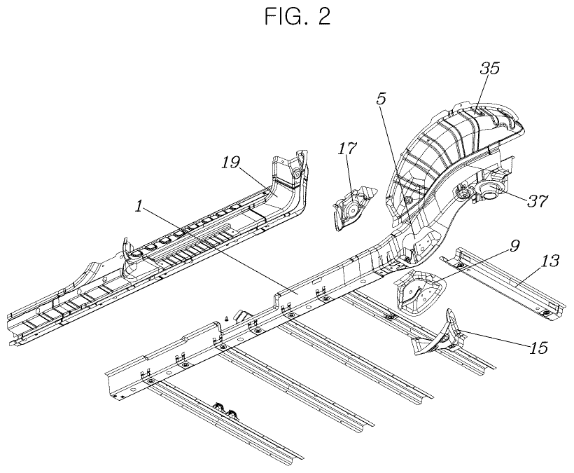

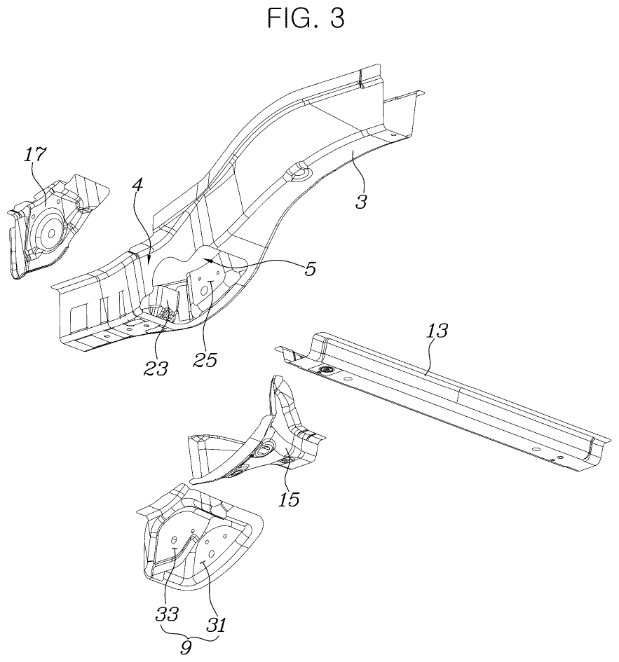

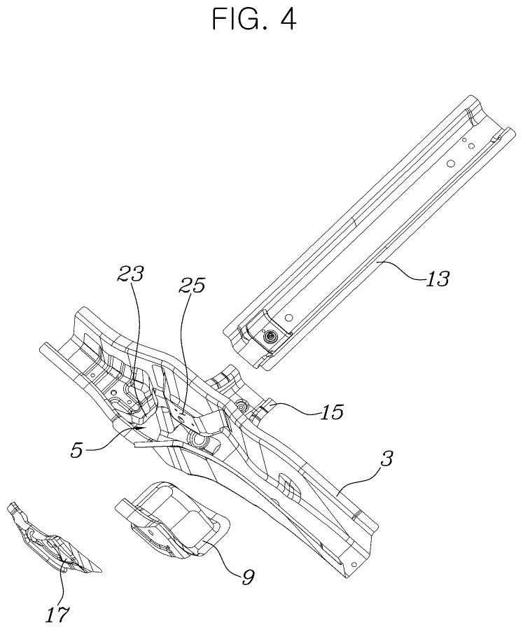

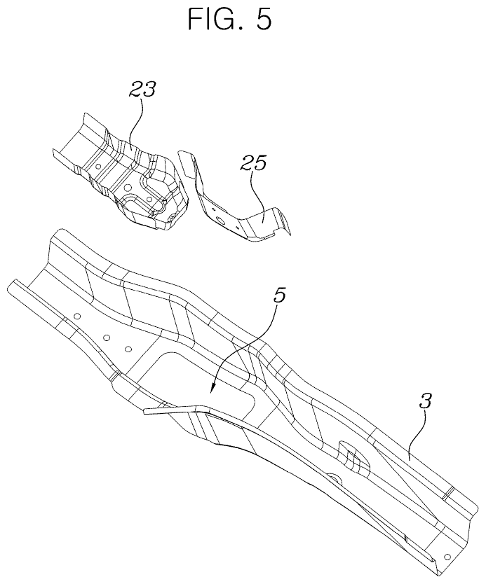

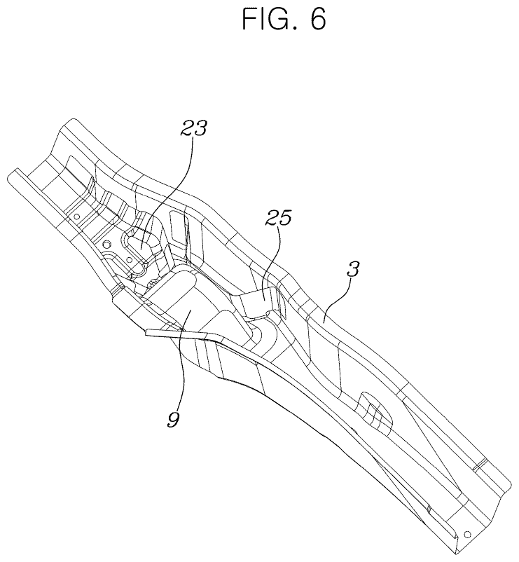

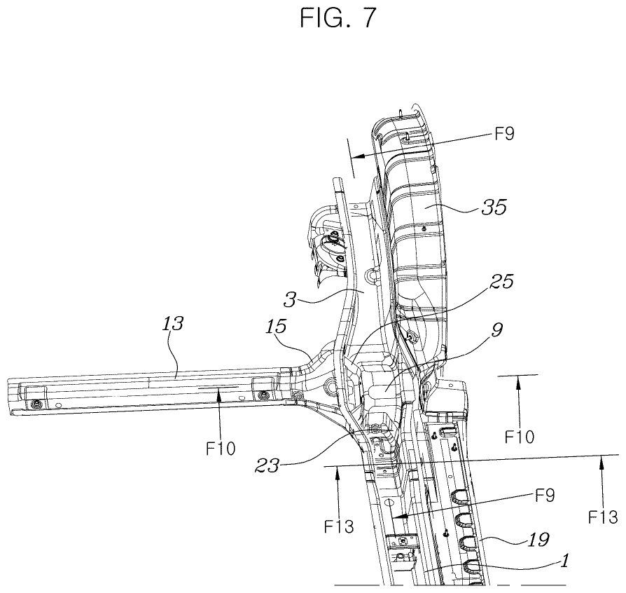

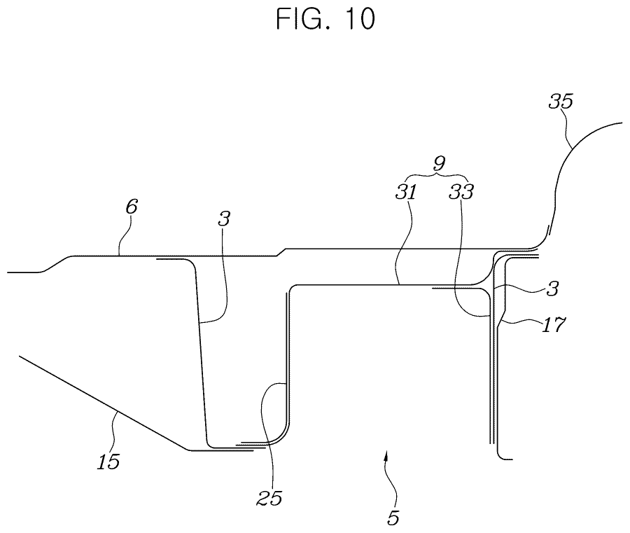

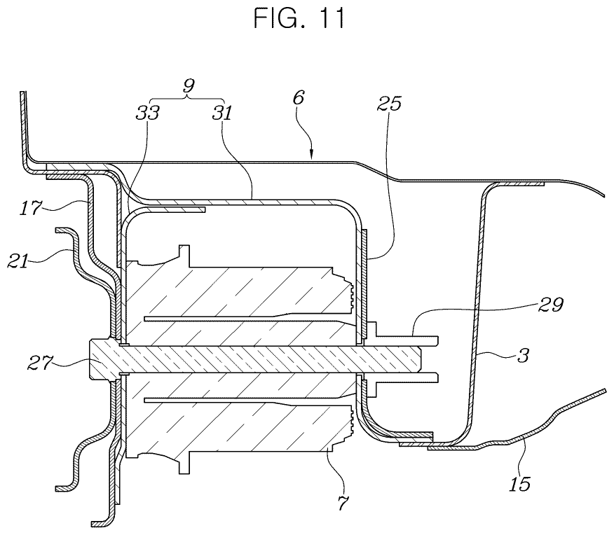

Referring to FIGS. 1 to 13, a vehicle structure of an embodiment of the present disclosure includes a rear side member 3 coupled to a rear side of a center side member 1, a mounting hole 5 formed in a kick-up portion 4 of the rear side member 3 so as to be open backward and downward, and a mounting bracket 9 inserted into and coupled to the mounting hole 5 and configured to rotatably support a front end portion of a trailing arm 7.

The center side member 1 can be located in the middle of each of both sides of the vehicle body so as to be elongated in a forward-backward direction. The rear side member 3 can be coupled to the rear side of the center side member 1, and a front side member (not shown) can be coupled to the front side of the center side member 1, thereby forming a frame of the vehicle.

A floor panel 6 can be mounted on the center side member 1 and the rear side member 3 to form a floor of the vehicle body.

As shown in the drawings, the rear side member 3 can be coupled to the rear side of the center side member 1, and the rear side thereof can extend backward and upward due to the kick-up portion 4, thereby securing a space in which a rear suspension 11 can be mounted.

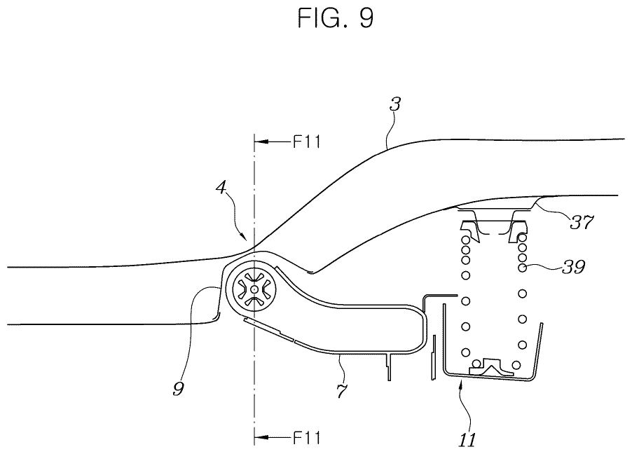

The rear suspension 11 may be of a coupled torsion beam axle (CTBA) type including a trailing arm 7. FIG. 9 is a cross-sectional view showing a mounted state of a CTBA type of rear suspension 11.

As can be seen in FIGS. 9-11, to rotatably support the front side of the trailing arm 7, the mounting hole 5 can be formed in the rear side member 3, and the front side of the trailing arm 7 can be inserted into the mounting bracket 9 inserted into and mounted in the mounting hole 5, so that the rotary shaft of the trailing arm 7 can be supported.

Because the rotary shaft of the trailing arm 7 can be supported inside the rear side member 3, it can be possible to more easily secure a space for mounting of the rear suspension 11.

As described above, to insert the rotary shaft of the trailing arm 7 into the rear side member 3, the mounting hole 5 can accommodate this. However, there can be a risk of the rear side member 3 being deteriorated in rigidity.

To obviate this problem, according to an embodiment of the present disclosure, the mounting bracket 9 can be mounted in the mounting hole 5 while allowing the rotary shaft of the trailing arm 7 to be supported inside the rear side member 3, and a plurality of reinforcing members, which will be described later, can be mounted to enhance the rigidity of a portion of the rear side member 3 in which the mounting hole 5 is formed. Accordingly, it can be possible to secure sufficient rigidity of the rear side member 3, thus ensuring safety of the vehicle in the event of a rear collision of the vehicle.

Similar to the center side member 1, the rear side member 3 can be formed to have a U-shaped section and to be elongated in the forward-backward direction of the vehicle. The mounting bracket 9 can be formed to have an inverted U-shaped section so as to overlap the U-shaped section of the rear side member 3 and to be inserted thereinto. The mounting bracket 9 can be coupled to the rear side member 3 so as to surround the entire periphery of the mounting hole 5, thus blocking communication between the upper side of the rear side member 3 and the lower side thereof.

In other words, the rear side member 3 can have a U-shaped section having an open upper portion and can be elongated in the forward-backward direction, and the mounting bracket 9 can be inserted into the mounting hole 5 in the rear side member 3, and the mounting bracket 9 can have an inverted U-shaped section having an open lower portion. Thus, the wall of the portion of the rear side member 3 in which the mounting hole 5 is formed can have a double-wall structure, and the entire periphery of the mounting hole 5 can be surrounded by the mounting bracket 9. Accordingly, when the mounting bracket 9 is mounted in the mounting hole 5, the mounting hole 5 in the rear side member 3 can be blocked, rather than remaining in an open state. As a result, the rigidity of the portion of the rear side member 3 in which the mounting hole 5 is formed can be enhanced.

The front end portion of the trailing arm 7 can be inserted into and mounted in the mounting bracket 9 so that the rotary shaft of the trailing arm 7 can be located inside the U-shaped section of the rear side member 3 and the inverted U-shaped section of the mounting bracket 9.

Accordingly, there can be no need to design the vehicle body to be unnecessarily high to secure a space for mounting of the rear suspension 11, and it can be advantageous in forming as flat a floor panel 6 as possible.

The portion of the rear side member 3 in which the mounting hole 5 is open can be formed to have a relatively large width in the lateral direction of the vehicle.

Because the mounting bracket 9 and the trailing arm 7 can be inserted into the mounting hole 5 and a plurality of reinforcing members, which will be described later, may need to be or may be specified to be additionally mounted, the portion of the rear side member 3 in which the mounting hole 5 is formed can be increased in width.

The vehicle structure of an embodiment of the present disclosure can further include a rear cross member 13, which can be mounted farther inward than the mounting hole 5 and can extend in the lateral direction of the vehicle, and a rear cross extension 15, which can be mounted between the rear cross member 13 and the rear side member 3 and can expand in a direction from the rear cross member 13 toward the rear side member 3 so as to surround the portion of the rear side member 3 in which the mounting hole 5 is formed.

The rear side member 3 can be connected at the portion thereof in which the mounting hole 5 is formed to the rear cross member 13, and thus can be is possible to obtain an effect of additionally enhancing the rigidity of the rear side member 3. In particular, because the rear cross member 13 can be connected to the rear side member 3 via the rear cross extension 15, the rear cross extension 15 may surround the entirety of the portion of the rear side member 3 in which the mounting hole 5 is formed, as described above. Thus, making use of the rear cross member 13 and the rear cross extension 15 can be advantageous in enhancing the rigidity of the rear side member 3.

In addition, the vehicle structure of an embodiment of the present disclosure can further include an outer reinforcing member 17, which can be mounted farther outward than the rear side member 3 to surround and reinforce the portion of the rear side member 3 in which the mounting hole 5 is formed.

In this way, the portion of the rear side member 3 oriented in the inward direction of the vehicle can be reinforced by the rear cross extension 15, and the portion of the rear side member oriented in the outward direction of the vehicle can be reinforced by the outer reinforcing member 17.

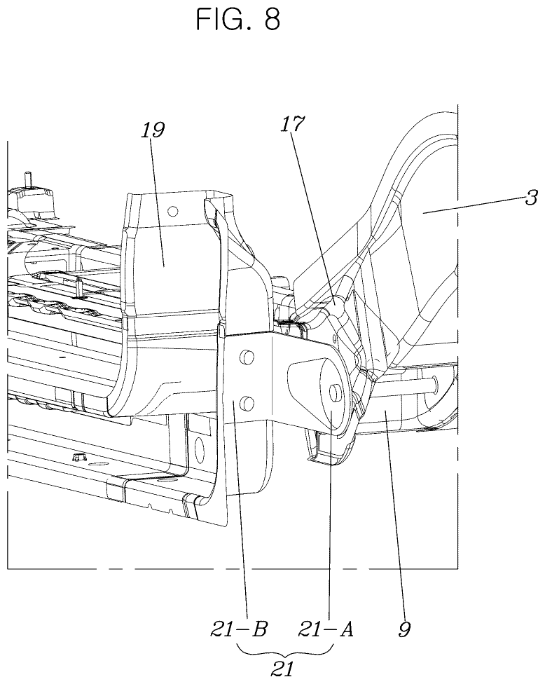

In addition, the vehicle structure of an embodiment of the present disclosure can further includes a side sill 19, which can be mounted farther outward than the center side member 1 and can extend in the forward-backward direction of the vehicle. As shown in FIG. 8, the rear end portion of the side sill 19 and the outer reinforcing member 17 may be connected to each other via a side sill connection reinforcing member 21 and may be supported thereby.

The side sill connection reinforcing member 21 can include a surface 21-A perpendicular to the rotary shaft of the trailing arm 7 and a surface 21-B parallel to the rotary shaft of the trailing arm 7, and the surface 21-A and the surface 21-B can be connected to each other. The surface 21-A perpendicular to the rotary shaft of the trailing arm 7 may be configured so as to support the rotary shaft of the trailing arm 7 together with the outer reinforcing member 17, and the surface 21-B parallel to the rotary shaft of the trailing arm 7 may be in surface contact with and coupled to the rear surface of the side sill 19.

Accordingly, in the event of an accident such as a rear collision of the vehicle, when impact force is transferred from the rear side of the vehicle to the front side of the vehicle through the rear side member 3, the impact force can be dispersed to the side sill 19 through the side sill connection reinforcing member 21, whereby the overall impact resistant performance of the vehicle body may be improved.

In addition, the vehicle structure of an embodiment of the present disclosure can further include a front reinforcing bracket 23 mounted inside the rear side member 3 at a position in front of the mounting bracket 9 to enhance coupling rigidity between the mounting bracket 9 and the rear side member 3.

The front reinforcing bracket 23 can be mounted so as to overlap a portion of the rear side member 3 that can overlap and can be coupled to the center side member 1.

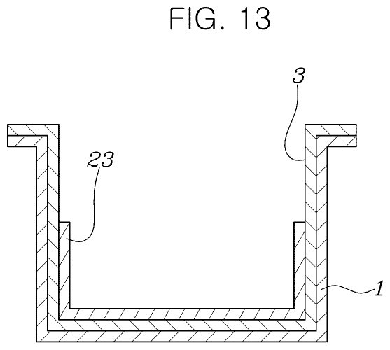

That is, as shown in FIG. 13, the front reinforcing bracket 23 can be mounted so as to overlap a portion of the rear side member 3 that can be coupled to the center side member 1, and thus all these three parts can have portions overlapping each other when viewed in section. As a result, the rigidity of the rear side member 3 can be further enhanced, and the front reinforcing bracket 23 can more firmly support the mounting bracket 9.

In addition, the vehicle structure of an embodiment of the present disclosure can further include an inner reinforcing bracket 25 mounted inside the rear side member 3 and interposed between the rear side member 3 and a portion of the mounting bracket 9 oriented in the inward direction of the vehicle to enhance coupling rigidity between the mounting bracket 9 and the rear side member 3 and to connect the mounting bracket 9 to the rear cross member 13 via the rear side member 3 and the rear cross extension 15.

In addition, a weld nut 29, to which can be fastened to a mounting bolt 27, which can be coupled to the rotary shaft of the trailing arm 7 during a process of forming the rotary shaft, can be coupled to the inner reinforcing bracket 25.

Accordingly, the mounting bolt 27 can be more firmly supported by the rear side member 3, and the inner reinforcing bracket 25 and the mounting bracket 9 can serve as plural partition walls divisionally supporting the internal space in the rear side member 3, whereby the rigidity of the portion of the rear side member 3 in which the mounting hole 5 is formed may be further enhanced.

In an embodiment, the mounting bracket 9 can include an inner mounting bracket 31, which can surround portions of the rear side member 3 located farther inward, forward, and backward than the mounting hole 5, and an outer mounting bracket 33, which can be coupled to the inner mounting bracket 31 and can surround a portion of the rear side member 3 located farther outward than the mounting hole 5.

That is, because the inner mounting bracket 31 and the outer mounting bracket 33 can be coupled to each other to form the mounting bracket 9, a sufficient space for receiving the trailing arm 7 inserted thereinto may be relatively easily defined in the mounting bracket 9, and the rigidity of the mounting bracket 9 may be effectively secured.

The portion of the rear side member 3 in which the mounting hole 5 is formed can be a portion from which the rear side member 3 coupled to the center side member 1 extends backward and upward, and can be formed so as to receive and support the rotary shaft of the trailing arm 7 of the rear suspension 11, thereby preventing the overall height of the vehicle from being increased to secure a space for mounting of the rear suspension 11.

In addition, the vehicle structure of an embodiment of the present disclosure can further include a rear wheel house panel 35 coupled to an upper side of the rear side member 3. The front end portion of the rear wheel house panel 35 can be coupled to the side sill 19, thereby forming a more robust vehicle body structure.

In addition, the vehicle structure of an embodiment of the present disclosure can further include a suspension support bracket 37 coupled to the rear side member 3 at a position behind the mounting hole 5 to mount the rear suspension 11.

Referring to FIG. 9, the upper end of a spring 39 constituting the rear suspension 11 can be supported by the suspension support bracket 37.

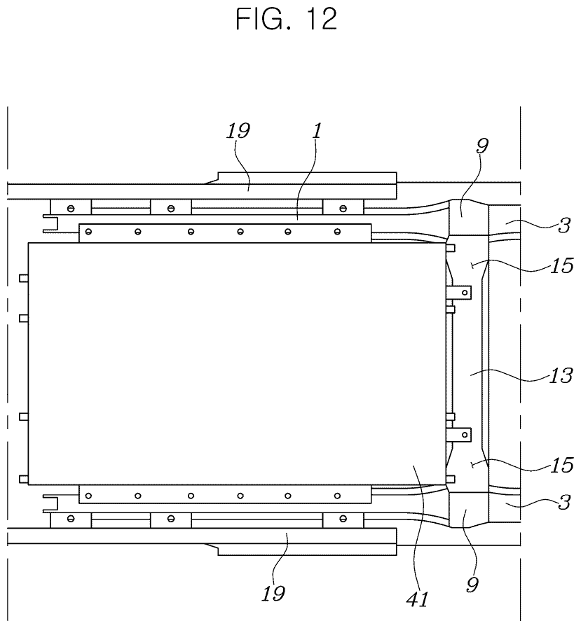

Referring to FIG. 12, the center side member 1 can be provided in a pair, and the pair of center side members 1 can be symmetrically positioned on both sides of the vehicle. A battery 41 can be mounted between the pair of center side members 1 and can be fixed to the pair of center side members 1 and the rear cross member 13.

The battery 41 can be a part provided to supply power to a motor of an electric vehicle.

In the event of a rear collision of the vehicle configured as described above, the rear side member 3 can withstand an impact load transferred from the rear side of the vehicle due to the above-described plurality of reinforcing members reinforcing the parts around the mounting hole 5 and can disperse the impact load transferred from the rear side of the vehicle to the side sill 19, and thereby can effectively prevent transfer of impact force to the battery 41, thus can safely protect the battery 41.

As can be apparent from the above description, a vehicle structure according to an embodiment of the present disclosure can allow the floor of a passenger compartment or a cargo carrying space to form as flat a surface as possible, and can secure a sufficient space for mounting of a rear suspension and sufficient rigidity of a part for mounting of the rear suspension, thereby can effectively prepare for a rear collision of a vehicle and, especially, can effectively protect a battery of an electric vehicle in the event of a rear collision of the electric vehicle.

Although example embodiments of the present disclosure have been disclosed for illustrative purposes, those skilled in the art can appreciate that various modifications, additions, and substitutions are possible, without departing from scopes and spirit of the disclosure as disclosed in the accompanying claims.

What is claimed is:

1. A vehicle structure comprising:
a rear side member coupled to a rear side of a center side member;
a mounting hole formed in a kick-up portion of the rear side member so as to be open backward and downward; and
a mounting bracket inserted into and coupled to the mounting hole, the mounting bracket being configured to rotatably support a front end portion of a trailing arm.

2. The structure of claim 1, wherein the rear side member is formed to have a U-shaped section and to be elongated in a forward-backward direction of a vehicle, and
wherein the mounting bracket is formed to have an inverted U-shaped section so as to overlap and to be inserted into the U-shaped section of the rear side member, and is coupled to the rear side member so as to surround an entire periphery of the mounting hole to block communication between an upper side of the rear side member and a lower side of the rear side member via the mounting hole.

3. The structure of claim 2, wherein the front end portion of the trailing arm is inserted into and mounted in the mounting bracket so that a rotary shaft of the trailing arm is located inside the U-shaped section of the rear side member and the inverted U-shaped section of the mounting bracket.

4. The structure of claim 3, wherein the portion of the rear side member in which the mounting hole is open is formed to have an enlarged width in a lateral direction of the vehicle compared to any other portions of the rear side member.

5. The structure of claim 3, further comprising:
a rear cross member mounted farther inward than the mounting hole and extending in a lateral direction of the vehicle; and
a rear cross extension mounted between the rear cross member and the rear side member and expanding in a direction from the rear cross member toward the rear side member so as to surround an inner side of the rear side member in which the mounting hole is formed.

6. The structure of claim 3, further comprising an outer reinforcing member mounted farther outward than the rear side member to surround and reinforce an outer side of the rear side member in which the mounting hole is formed.

7. The structure of claim 6, further comprising a side sill mounted farther outward than the center side member and extending in a forward-backward direction of the vehicle, wherein a rear end portion of the side sill and the outer reinforcing member are connected to each other via a side sill connection reinforcing member.

8. The structure of claim 7, wherein the side sill connection reinforcing member comprises:
a first surface perpendicular to the rotary shaft of the trailing arm; and
a second surface parallel to the rotary shaft of the trailing arm and connected to the first surface, wherein the first surface is configured to support the rotary shaft of the trailing arm together with the outer reinforcing member, and wherein the second surface is in surface contact with and coupled to a rear surface of the side sill.

9. The structure of claim 3, further comprising a front reinforcing bracket mounted inside the rear side member at a position in front of the mounting bracket.

10. The structure of claim 9, wherein the front reinforcing bracket is mounted such that the front reinforcing bracket, the rear side member, and the center side member overlap with each other.

11. The structure of claim 5, further comprising an inner reinforcing bracket mounted inside the rear side member and interposed between the rear side member and an inward portion of the mounting bracket oriented in an inward direction of the vehicle to enhance coupling rigidity between the mounting bracket and the rear side member and to connect the mounting bracket to the rear cross member via the rear side member and the rear cross extension.

12. The structure of claim 11, further comprising a weld nut coupled to the inner reinforcing bracket, wherein the weld nut is positioned and configured to fasten to a mounting bolt of the rotary shaft of the trailing arm.

13. The structure of claim 3, wherein the mounting bracket comprises:
an inner mounting bracket surrounding an inward-side portion of the rear side member located farther inward, forward, and backward than the mounting hole; and
an outer mounting bracket coupled to the inner mounting bracket and surrounding an outward-side portion of the rear side member located farther outward than the mounting hole.

14. The structure of claim 1, wherein the kick-up portion of the rear side member extends backward and upward and is formed proximate to where the rear side member is coupled to the center side member; and
wherein the mounting hole is located at a portion where the rear side member starts extending rearward and upward from an area where it is coupled to the center side member.

15. The structure of claim 7, further comprising a rear wheel house panel coupled to an upper side of the rear side member, wherein the rear wheel house panel comprises a front end portion coupled to the side sill.

16. The structure of claim 15, further comprising a suspension support bracket coupled to the rear side member at a position behind the mounting hole and configured to mount a rear suspension thereto.

17. The structure of claim 5, wherein the center side member is provided in a pair,
wherein the pair of center side members is symmetrically positioned on both sides of the vehicle,
wherein a battery is mounted between the pair of center side members, and
wherein the battery is fixed to the pair of center side members and the rear cross member.

18. A vehicle structure comprising:
a rear side member coupled to a rear side of a center side member;
a mounting hole formed in a kick-up portion of the rear side member so as to be open backward and downward;
a mounting bracket inserted into and coupled to the mounting hole, the mounting bracket being configured to rotatably support a front end portion of a trailing arm;
a rear cross member mounted farther inward than the mounting hole and extending in a lateral direction of the vehicle; and
a rear cross extension mounted between the rear cross member and the rear side member and expanding in a direction from the rear cross member toward the rear side member so as to surround at least part of an inner side of the kick-up portion of the rear side member.

19. The structure of claim 18, further comprising:
an outer reinforcing member mounted farther outward than the rear side member to surround and reinforce at least part of an outer side of the kick-up portion of the rear side member; and
a front reinforcing bracket mounted inside the rear side member at a position in front of the mounting bracket, wherein the front reinforcing bracket is mounted such that the front reinforcing bracket, the rear side member, and the center side member overlap with each other.

20. A vehicle comprising:
a trailing arm of a rear suspension system;
a battery; and
a vehicle structure, wherein the vehicle structure comprises:
a pair of center side members being symmetrically positioned on both sides of the vehicle,
a rear side member coupled to a rear side of one of the center side members;
a mounting hole formed in a kick-up portion of the rear side member so as to be open backward and downward; and
a mounting bracket inserted into and coupled to the mounting hole, the mounting bracket being configured to rotatably support a front end portion of the trailing arm;
a rear cross member mounted farther inward than the mounting hole and extending in a lateral direction of the vehicle; and
a rear cross extension mounted between the rear cross member and the rear side member and expanding in a direction from the rear cross member toward the rear side member so as to surround at least part of an inner side of the kick-up portion of the rear side member, wherein the battery is mounted between the pair of center side members, and wherein the battery is fixed to the pair of center side members and the rear cross member.
